(19) United States
(12) Patent Application Publication
(10) Pub. No.: US 2014/0076483 A1
(43) Pub. Date: Mar. 20, 2014

(54) PIPE JOINT COATING

(71) Applicant: Subsea Services International, INC., Houston, TX (US)

(72) Inventors: Strewn S. PIRIE, Katy, TX (US); Darrell L. WHITE, Katy, TX (US); V. Scott MOODY, Richmond, TX (US)

(73) Assignee: Subsea Services International, INC., Houston, TX (US)

(21) Appl. No.: 14/088,187

(22) Filed: Nov. 22, 2013

Related U.S. Application Data
(62) Division of application No. 13/095,233, filed on Apr. 27, 2011.
(60) Provisional application No. 61/328,464, filed on Apr. 27, 2010.

(51) Int. Cl. F16L 57/00

(52) U.S. Cl. CPC F16L 57/00
USPC 156/187

(57) ABSTRACT

Exposed pipe joints formed of adjacent lengths of corrosion protective coated pipe sections have a protective sheet of synthetic resin material wound about the joint between the adjacent segments of coated pipe. The synthetic resin sheet is deployed from a reel on a coating applicator machine. The pipe joint and adjacent coated pipe sections are initially heated. The sheet of synthetic resin is then wrapped in successive layers over the joint. Pressure is also applied to the sheet material as it is being wrapped. The sheet layers are heated after being applied onto the joint. Wrapping and heating continues during deployment of the sheet material from the reel, and the resin sheet is cylindrically wound over the joint in successive layers until the desired coating thickness is obtained. The successive layers of wrapped sheet material fuse to form an integral protective coating over the pipe joint and the adjacent coated pipe sections.

### RELATED APPLICATIONS

This application is a divisional application of, and claims priority and benefit to, U.S. Non-Provisional application Ser. No. 13/095,233, entitled “Pipe Joint Coating” filed on Apr. 27, 2011, which claims priority to U.S. Provisional Patent Application No. 61/328,464, entitled “Pipe Joint Coating” filed on Apr. 27, 2010, the disclosures of which are incorporated herein by reference in their entirety.

### BACKGROUND OF THE INVENTION

1. Field of the Invention

The present invention relates generally to providing a protective synthetic resin coating, and to methods of installing such a coating, to expose end sections of pipeline being laid in a body of water.

2. Description of the Related Art

It is conventional in the pipeline industry to coat steel pipe on pipelines for corrosion protection purposes. Such coatings were applied on the exterior surface of each section or length of pipe, except for exposed short end portions or stubs of the pipe initially left bare or unprotected so that the pipe end sections could be welded together to form the pipeline as it was being laid. The coating on pre-coated section of the pipe is called the “parent coating”. After welding the sections together, the uncoated area around the weld must then be coated for corrosion protection. This area is called the “field joint” or “joint”. One type of parent coating that is often used is a Three Layer Coating, which might be Polypropylene (3LPP or Three Layer PP), or Polyethylene (3LPE or Three Layer PE). Three Layer coating is a complete corrosion protection system composed of three elements (layers) working together. The first layer is a fusion bonded epoxy coating. The second layer is a chemically modified PP or PE adhesive. The third layer is a co-polymer outer layer in varying thicknesses, usually several millimeters thick. Combined as a system these elements work together to protect the pipe from undesirable corrosion.

The end portions of adjacent lengths of the coated pipe were welded together as the pipeline was being formed. The bare metal of the end portions or stubs adjacent the welds comprise the joint area or field joint. The joint area also had to be provided with a corrosion protective coating system. Some of the methods that have been used most often are (1) Heat Shrink Sleeves (2) Polypropylene Flame Spray, (3) Spiral Tape Wrap, and (4) Longitudinal Sheet Wrap. The Heat Shrink Sleeve is a sheet of thermoplastic that has been irradiated to cross-link the molecules and stretched. When placed around the pipe, it is heated with an open flame causing the material to shrink around the pipe. The flame is applied manually by a skilled operator who also uses a roller to roll out air bubbles from under the sleeve. Performance of the Heat Shrink Sleeve is therefore dependent on operator skill and consistency in evenly applying the flame and rolling out the air bubbles. Application of an open flame, as opposed to other heat sources, to thermoplastics has been known to oxidize the parent coating of the pipe and degrade the applied polypropylene powder. This thermally ages the material and may reduce the service life. The open flame is potentially a safety hazard, particularly in the confined space of an offshore pipe-laying vessel. Polypropylene flame spray is a process where polypropylene powder is sprayed on the pipe in conjunction with an open flame to melt and deposit the polypropylene on the pipe. Performance of the Polypropylene Flame Spray is therefore dependent on operator skill and consistency in evenly applying the flame spray. Application of an open flame as opposed to other heat sources, to thermoplastics has been known to oxidize the parent coating of the pipe and the thermoplastic of the sleeve material. This thermally ages the material and may reduce the service life. The open flame is potentially a safety hazard, particularly in the confined space of an offshore pipe-laying vessel. Spiral Tape Wrap is a process where a polypropylene tape of approximately three inches wide is wrapped in a spiral where the tape overlaps each preceding wrap by about 66%. This requires the wrap machine to circle the pipe roughly 16 to 20 times to cover a 16-inch joint. This process results in a wrap with numerous spiral seams down the length of the joint; each seam is a potential failure point.

The longitudinal Sheet Wrap involves wrapping a sheet of thermoplastic material around the pipe. So far as is known, however, these efforts have required that the thermoplastic material be preheated in an oven to a suitable temperature before it was applied to the fusion bonded epoxy layer. Additional heat is then applied as it is wrapped. One such effort was based on heating the sheet material during its application onto the pipe and its fusion bonded epoxy layer. However, control of the temperature to assure that the sheet material was properly and evenly heated was a problem. Uneven heat application can lead to the thermoplastic not bonding to the pipe and the parent coating. One technique proposed the use of open flame heating of the sheet material, despite the known undesirability on a pipe laying barge of a technique using open flame.

Another effort was to heat the sheet material separately on the barge to insure that the desired temperature conditions were achieved in the sheet material before moving it to the pipeline joint for application. During pipe laying, operating time control and delay prevention were highly important. Separate heating of the sheet material to required temperature conditions and maintaining the material at such temperature conditions required co-ordination and time management, which was problematic on pipe laying barges.

Another proposed technique relied on wrapping an adhesive layer as a second intermediate layer over the fusion bonded epoxy coating and then subsequent wrapping of a third layer in the form of an outer protective layer over the intermediate adhesive layer and the fusion bonded epoxy coating. So far as is known, there were problems with properly heating each of the materials of the second and third layers.

Another techniques, such as in U.S. Pat. No. 6,059,319, was directed to forming a cylindrical sleeve seal over the gap between adjacent lengths of plastic coated pipe. Filler panels of butyl rubber, bitumastic, rubberized bitumen or similar materials of a size approximating the interior space within a cylindrical sleeve were used in an attempt to provide corrosion protection. However, gaps and spaces were often present between the various elements, such as between the filler panel material, the pipe coating and the cylindrical sleeve seal. There was thus a risk of fluid leakage and corrosion. For offshore pipelines, particularly in deeper bodies of water, the hydrostatic pressures increased the concerns of fluid leakage through these gaps and spaces and resulting possible corrosion.

### SUMMARY OF THE INVENTION

Briefly, the present invention provides a new and improved machine for coating a pipe joint between welded end stubs of coated sections of pipe for a pipeline. The coating is in the form of a cylindrically wound unheated sheet of synthetic resin. The machine according to the present invention for applying the coating includes a mounting frame mountable on adjacent coated sections of the pipeline to span the pipe joint being coated and a transport carriage rotatably movable on the mounting frame to move circumferentially about the pipe joint. A storage reel is mounted on the transport carriage for storing a supply of the unheated sheet of synthetic resin to be wound about the pipe joint. An applicator roller is mounted on the carriage frame and applies the unheated sheet of synthetic resin from the storage reel onto the pipe joint as the transport carriage moves about the circumference of the pipe joint. A heater is mounted on the transport carriage to heat the applied unheated sheet of synthetic resin after it has been applied to the pipe joint to preheat the substrate and the parent coating overlap area, the newly applied unheated sheet of synthetic resin material, and the previously applied material on subsequent revolutions of the applicator.

The present invention also provides a new and improved method of applying a protective coating to a pipe joint between welded end stubs of coated sections of pipe for a pipeline with an unheated sheet of synthetic resin from a storage reel on a transport carriage mounted on the pipeline. The unheated sheet of synthetic resin is being unreeled from the storage reel and applied to the pipe joint the transport carriage moves about the circumference of the pipe joint. As the carriage frame moves circumferentially about the pipe joint, the applied portion of the unheated sheet of synthetic resin on the pipe joint is heated. The heated portion of the applied unheated sheet of synthetic resin fuses the synthetic resin onto the pipe joint and forms an integral protective coating. The transport carriage may be rotated for one or more revolutions about the pipe joint to cylindrically apply a required number of layers of the heated sheet of synthetic resin to form the protective coating on the pipe joint.

In accordance with various embodiments, there is provided a method for applying a protective coating to a pipe joint between welded end stubs of coated sections of pipe for a pipeline with an unheated sheet of synthetic resin from a storage reel on a transport carriage mounted on the pipeline. The method includes the steps of unreeling the unheated sheet of synthetic resin from the storage reel, and applying the unheated sheet of synthetic resin to the pipe joint. The method further includes applying pressure to the unheated sheet of synthetic resin as it engages the pipe joint to press the synthetic resin on the pipe joint into a unitary coating, and heating the unheated sheet of synthetic resin after its application to the pipe joint from the storage reel. Further, the method includes rotating the transport carriage about the pipe joint to cylindrically apply successive layers of the heated sheet of synthetic resin to the pipe joint.

In accordance with various embodiments, the method further includes the step of applying tensile forces to the unheated sheet of synthetic resin as it is being applied to the pipe joint.

In accordance with various embodiments, the method further includes the step of smoothing the heated sheet of synthetic resin after it is applied to the pipe joint.

In accordance with various embodiments, the step of heating includes applying infrared heat.

### BRIEF DESCRIPTION OF THE DRAWINGS

FIG. 1 is a side elevation view of a pipe coating machine according to the present invention.

FIG. 2 is an isometric view of a portion of the pipe coating machine of FIG. 1.

FIG. 3 is an enlarged isometric view of an encircled portion identified by the numeral 3-3 of the structure shown in FIG. 2.

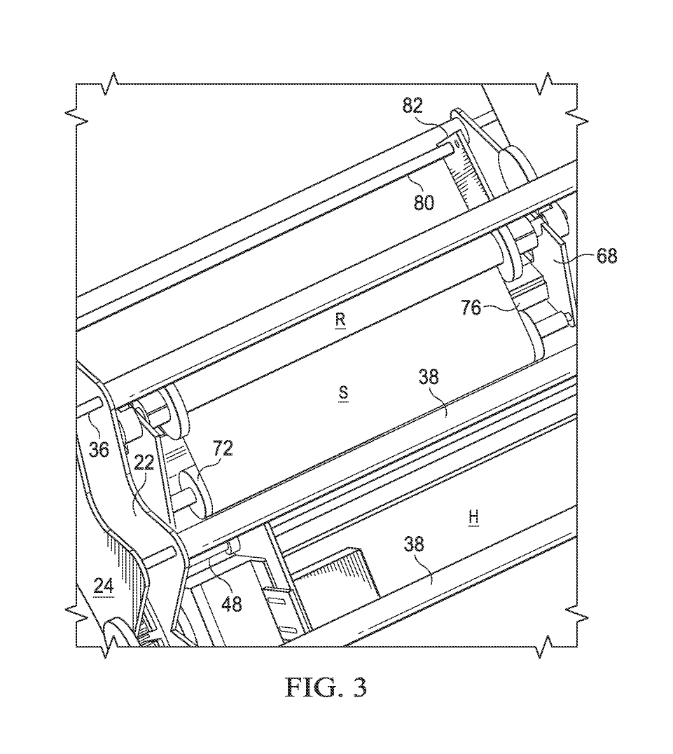

FIG. 4 is another isometric view of a portion of the pipe coating machine of FIG. 1.

FIG. 5 is an enlarged isometric view of a portion of the structure shown in FIG. 1.

FIG. 6 is a top view of the pipe coating machine of FIG. 1.

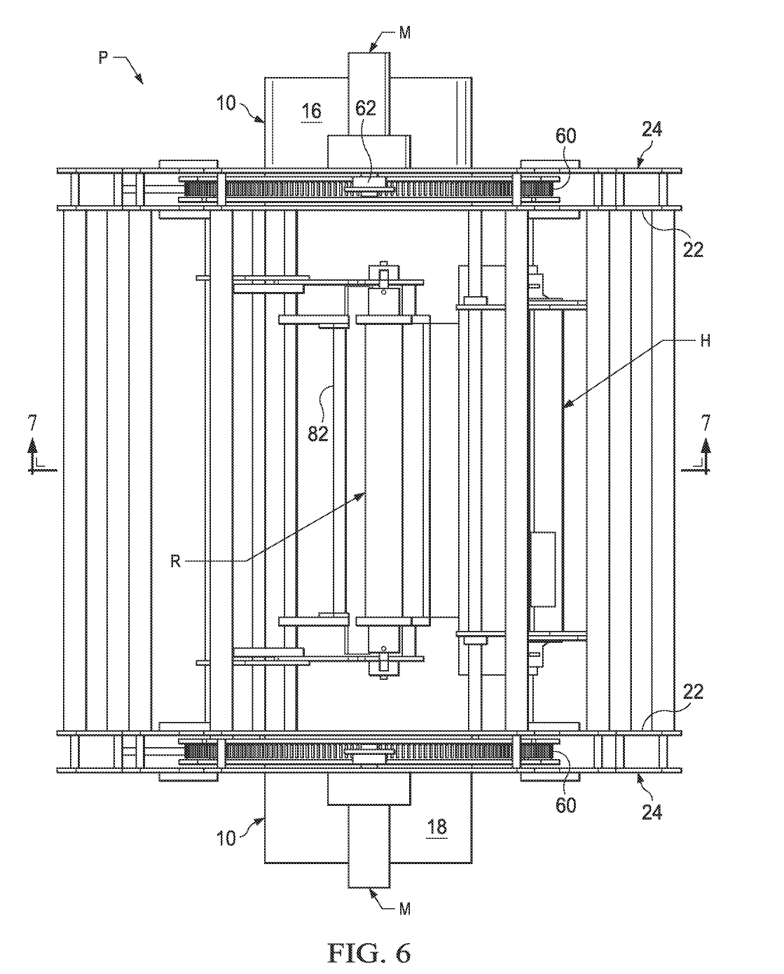

FIG. 7 is a vertical cross-sectional view taken along the lines 7-7 of FIG. 6.

FIG. 8 is a vertical cross-sectional view like that of FIG. 7 with certain components of the machine moved to different operating positions.

### DETAILED DESCRIPTION OF THE PREFERRED EMBODIMENTS

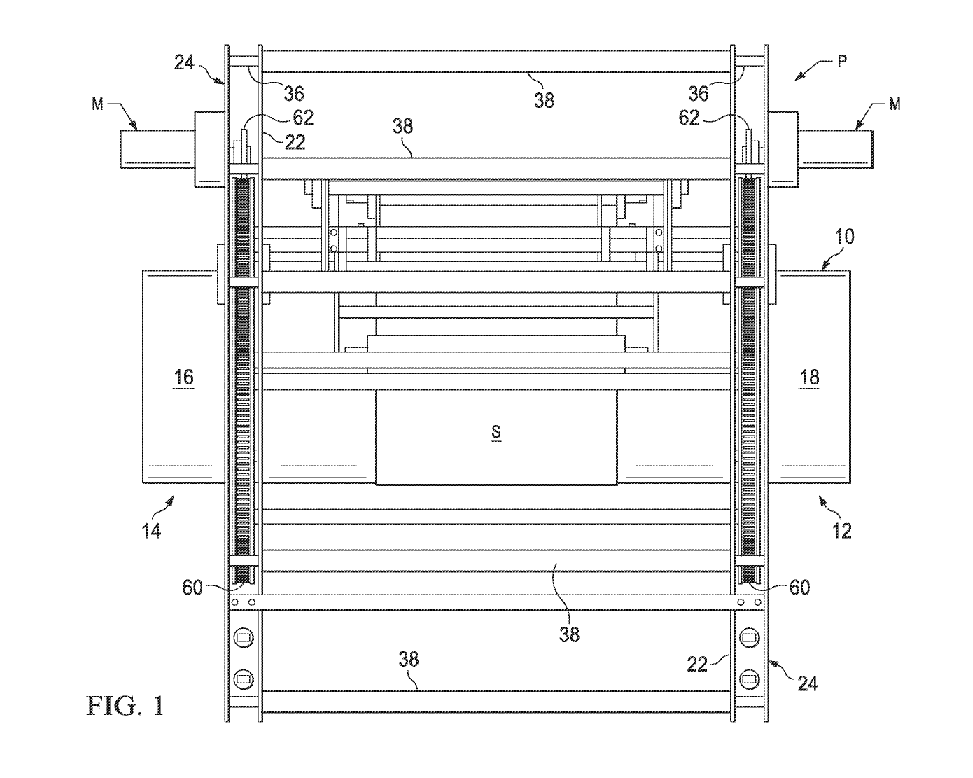

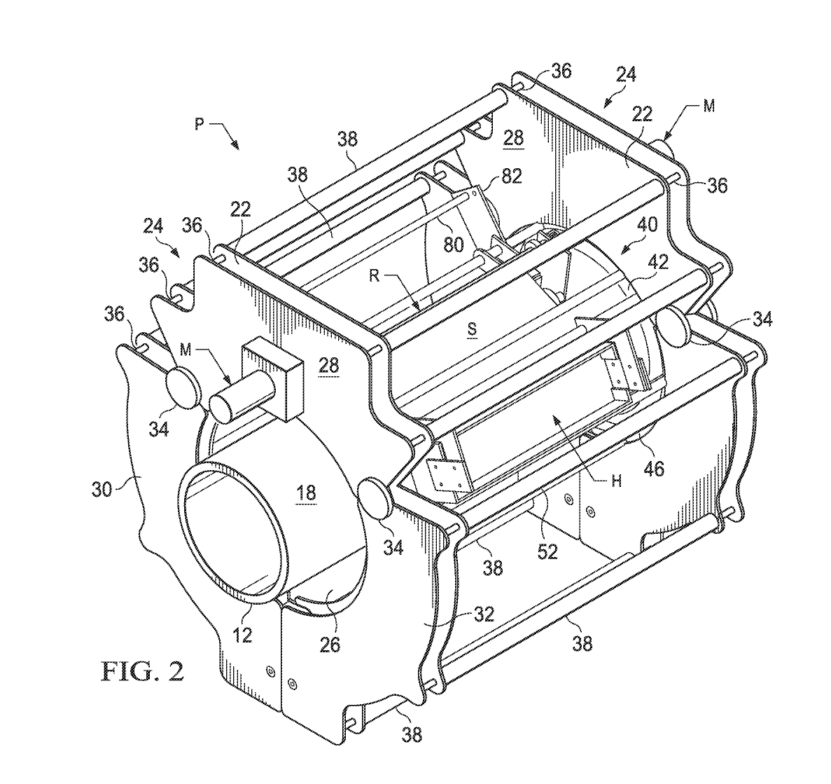

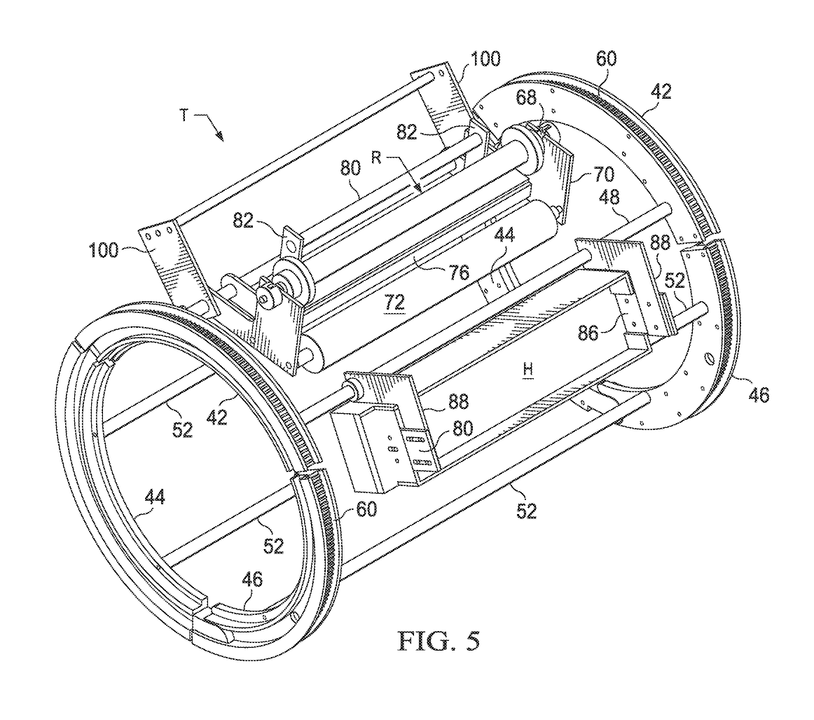

In the drawings a segment of a pipeline 10 is shown (FIG. 1) formed by welding two steel pipe sections 12 and 14. The pipeline 10 may be of the type being laid either in a body of water from a pipe laying barge, or in a land based pipeline being laid across terrain. The pipeline 10 is shown in FIG. 1 with a pipe coating machine P according to the present invention mounted thereon for coating a pipe joint between the pipe sections 12 and 14 with a cylindrically wound sheet S of synthetic resin. As will be set forth, the sheet S of synthetic resin is supplied by unreeling from a storage reel R (FIG. 2) mounted on a transport carriage T (FIG. 5). The transport carriage T is rotatably movable on a mounting frame F (FIGS. 1 and 2) positioned on adjacent coated sections 12 and 14 of the pipeline 10 to span the pipe joint being coated. The transport carriage is driven by one or more motors M to move circumferentially about the pipe joint and cylindrically wrap a suitable number of layers of the sheet S about the pipe joint.

Because the pipeline 10 is being laid in the presence of water, the steel in the pipe sections require a corrosion protective coating over its outer surface along its length. Additionally, it is required that the physical integrity of a corrosion protective coating once applied be maintained. Damage to the protective coating by contact with external objects or forces, particularly when the pipeline is also subject to hydrostatic forces at installed depths in the body of water or the effects of ground water can be a problem. A damaged protective coating results in water access to the metal of the pipeline with attendant undesirable corrosion problems.

A conventional practice has been to apply a fusion bonded epoxy as a corrosion protective coating and then enclose the fusion bonded epoxy with an outer protective coating 16 and 18 associated with the pipe sections 12 and 14.

Fusion bonded epoxy coating is an epoxy based powder coating process used to protect steel pipe in pipelines from corrosion. Fusion bonded epoxy coatings are thermosetting polymer coatings which are applied in powder form to a heated steel pipe to be coated. On application, the applied powder materials melt and are converted to a liquid which wets and flows onto the steel pipe surface. Due to a chemical cross-linking action in the presence of heat, the liquid formed by the component powders converts into a solid coating during a process known as fusion bonding. It should be noted that there are other corrosion protection first layers such as liquid epoxy that could be used instead of fusion bonded epoxy.

The outer protective coatings 16 and 18 serve as an outer coat material or cover of suitable thickness over the fusion bonded epoxy. Such coatings are typically formed of polypropylene. A typical thickness for an outer protective coating 16 and 18 and the protected lawyer of fusion bonded epoxy could, for example, be several millimeters, such as three or so. It should be understood that other thicknesses could as well be provided, depending on pipeline requirements, water condition, floor conditions in the body of water, ground conditions and similar factors.

It also should be understood that other suitable synthetic resins such as nylon, polyethylene, polystyrene, epoxies and other thermoplastic materials may be used as outer coatings, as well. The outer coatings 16 and 18 cover the corrosion protective coating applied to pipe sections 12 and 14 circumferentially and longitudinally except for a stub end portion of each pipe end. The pipe ends or stubs are exposed and extend from the outer coatings 16 and 18 to facilitate welding of the two pipe sections 12 and 14 together as sections of the pipeline 10. However, the exposed pipe stubs or ends are not coated with insulation coating in the pipeline 10 prior to the stubs being welded together.

A gap or joint 20 is thus present after joint welding at the location of the exposed pipe ends. As will be described below, a protective coating is formed according to the present invention to protect the metal gap or joint 20 by application of the sheet S of synthetic resin according to the present invention. The sheet S may be applied as an outer protective coating over a corrosion protection layer of fusion bonded epoxy of other material. Also, in certain instances if a suitable synthetic resin material as the sheet S, the synthetic resin material may be applied directly to the stub portions and serve as both a corrosion protective layer and its own protective coating.

Accordingly to the present invention, the sheet S is preferably of a polymeric thermoplastic material. The present invention may be used with a number of materials for the sheet S. Examples of such materials for the sheet S include a heat sealable, thermosetting hybrid coating available from 3M Corporation as SCOTCHKOTE™ PNC 1011; a polypropylene based pipe coating material available from Borealis A. G. called BORCOAT™ BB 127E, a polypropylene based pipe coating material available from Lyondell Basell Industries as a MOPLEN™ EP60 pipe coating; or a copolymer modified with adhesive and available as HIFAX™ from EP5 10/60 from Lyondell Basell Industries. Some of these options include an adhesive in the sheet material. If adhesive is not included in the material, it is applied in the FBE application process prior to applying the sheet. Other thermoplastic materials with comparable characteristics may also be used as material for the sheet S. The sheet S is contained in the supply reel or spool R, which is mounted on the transport carriage T. The sheet S is of a suitable thickness such as 1 millimeter and is cylindrically wound onto the pipe joint to form a protective coating.

The thickness of the material in the sheet S is based on the thickness of the protective coating to be formed and the number of wraps in which the sheet is to be applied, and various thicknesses of several millimeters may be used, if desired. Once applied, the outer diameter of the protective coating formed by the wrapped material of the sheet S should correspond to the outer diameter of the pipe sections with the outer protective coatings 16 and 18. The sheet S is also of sufficient width to cover the longitudinal width of the bare pipe joint to be coated and overlaps to some suitable extent, generally in excess of one inch onto adjacent cylindrical end areas of protective 16 and 18.

The machine P is mounted on the pipeline 10 by the mounting frame F. The frame F includes at its opposite ends an inner or first mounting ring 22 and an outer or second mounting ring 24 located at spaced positions from each other opposite sides of the area adjacent the gap 20 where the pipe joint to be coated is located. The mounting rings 22 and 24 have conventional inwardly extending spacer blocks which engage the outer protective coating portions of the pipe sections adjacent the pipe joint 20 and position the machine on the pipeline 10. Each of the mounting rings 22 and 24 has an enlarged central passage or opening 26 formed therethrough so that the pipeline 10 may be received in the machine P and moved along the its length for barge operations and offshore pipe laying. In this way, successive ones of the pipe joints in the pipeline 10 may have protective coatings applied by the machine P.

For pipelines being laid in land operations, the machine is P is positioned about a joint 20 for coating and then removed after application of a protective coating. The machine P is then moved to the next pipe joint 20 along the pipeline 10 to be coated and mounted about the joint for application of a protective coating.

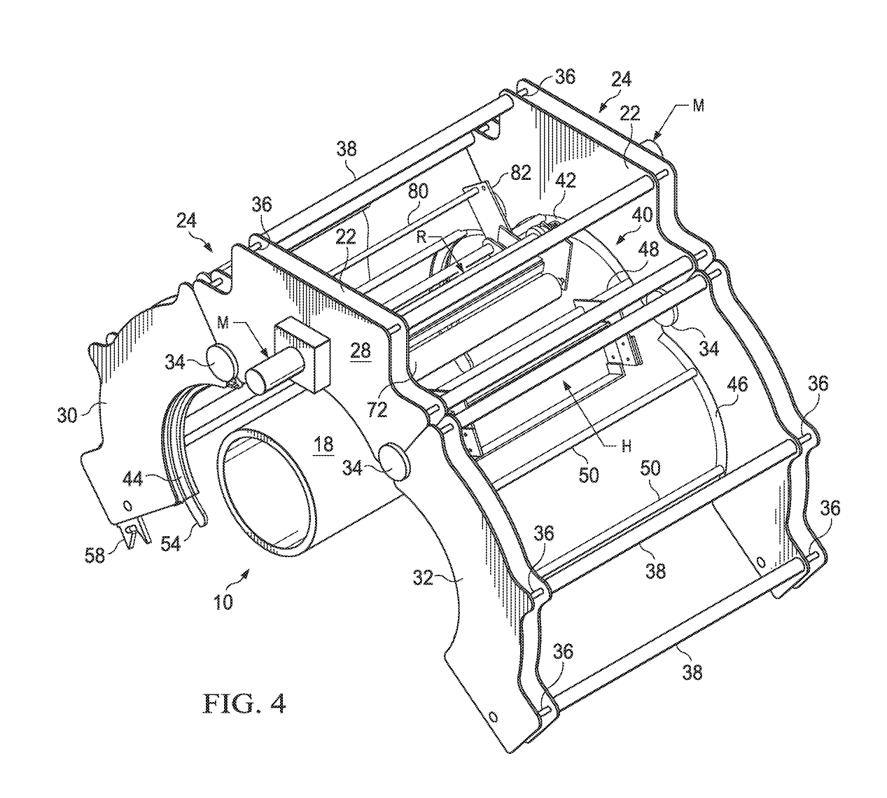

The mounting rings 22 and 24 are formed of three separate component plates or ring segments including an upper segment 28 (FIG. 4) and two movable lower plate segments 30 and 32. The movable lower plate segments 30 and 32 pivot between an open position (FIG. 4) and a closed position (FIG. 2) about hinges 34 under forces from a piston or other force applying mechanism. The hinges 34 are mounted at lower side portions on each side of the upper segments. In this manner the mounting frame F initially positions the machine on the pipeline for pipe coating to be performed.

The inner and outer mounting rings 22 and 24 at each end of the frame F are connected to each other by connector rods 36. The inner mounting rings 22 at each end of the frame F are connected to each other by longitudinally extending connector rods 38

Each of the inner mounting rings 22 are also provided with a circular space (FIG. 2) into which a circular support ring 40 (FIGS. 2 and 5) of the transport carriage T is mounted. The support rings 40 are formed of three connected arcuate connector segments: a central connector segment 42 and two pivotally movable connector segments 44 and 46. The central connector segment 42 of each of the support rings 40 is mounted with the upper segment 28 of the adjacent inner mounting ring 22 by bolts, screws or other suitable fasteners. Similarly, the pivotally movable connector segments 44 and 46 of the support rings 40 are mounted with one of the movable lower plate segments 30 and 32, respectively, of the adjacent inner mounting ring 22 by bolts, screws or other suitable fasteners. The upper connector segments 42 of the two spaced support rings 40 are connected together by longitudinally extending connector rods 48, while the pivotally movable connector segments 44 and 46 of the space support rings 40 are connected to their counterpart connector at the opposite end by connector rods 52.

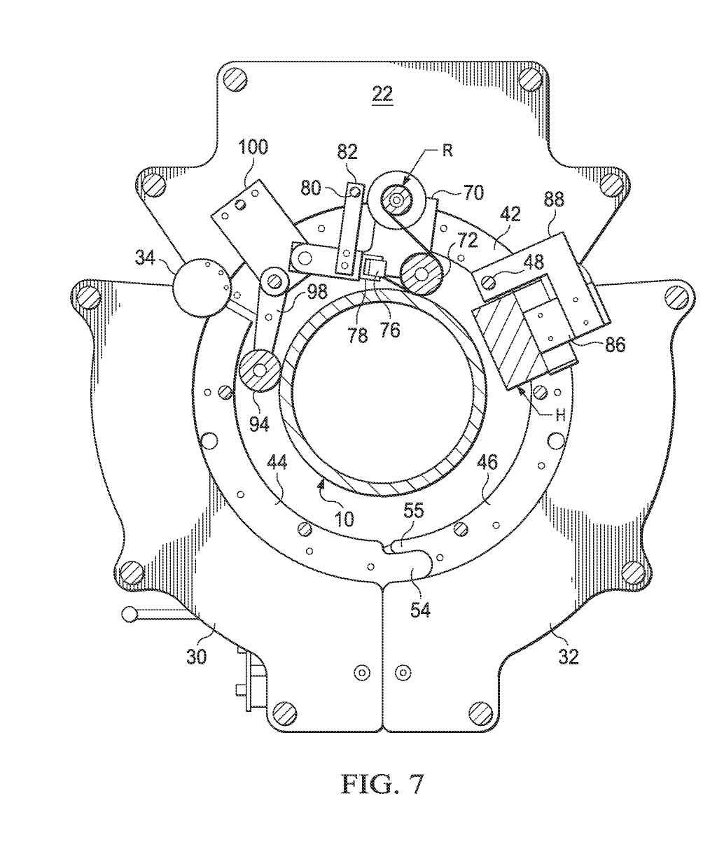

The connector segments 44 and 46 pivot about the hinges 34 along with the movement of the plate segments 30 and 32, respectively, and move in conjunction with them between the open position (FIG. 4) and the closed position (FIG. 2). The connector segments 44 are provided with a locking tab or lug 54 (FIG. 7) which fits into and is engaged in a receptor slot 55 on the adjacent connector segment 46.

Similarly, plate segments 30 are provided with a locking jaw or detent 58 (FIG. 4)or other suitable retaining or locking mechanism which engages a rod, pawl or other connector on the adjacent plate segment 32 to lock the segments 30 and 32 together in the closed position (FIG. 2).

A chain or gear ring 60 is mounted on an outer circumferential portion on each of the circular support rings 40 of the transport carriage T. When the machine is in the closed position on the pipeline 10, the chain ring 60 forms a continuous circular track. The chain rings 60 of the support rings 40 are engaged with and driven by a sprocket gear 62 which receives operating power from a motor M mounted on the upper segment 28 of an outer mounting ring 24 of the mounting frame F. In the closed position of the machine P (FIG. 2) the motors M through their respective sprocket gears 62 drive chain ring 60 and thus the circular support rings 40 and rotate the transport carriage T circumferentially in repeated cycles around the pipe joint 10 being coated.

The power source motors M according to the preferred embodiment may take the form of an electric driven motor with speed and rotation direction control and of suitable torque capacity, or if desired a hydraulically or pneumatically driven one. A suitable motor can be, for example a Model 6470K64 available from McMaster-Carr Supply Company. It should be understood that motors from other sources may be used.

The storage reel R for the sheet S of synthetic resin material is mounted for rotational movement with a support shaft 68 with respect to a mounting plate 70. The mounting plates 70 are pivotally movable with respect to their respective central connector segment 42 of the support rings 40. An applicator roller 72 is also mounted for rotational movement at each end on the mounting plates 70.

The grip bar 76 is a rectangular bar that fits into a channel or receiving guide and forms a gap or slot into which a leading edge or tail of the sheet S is inserted. The grip bar 76 holds the leading edge of the material away from contact until it is applied to the pipe at the start of the wrapping process.

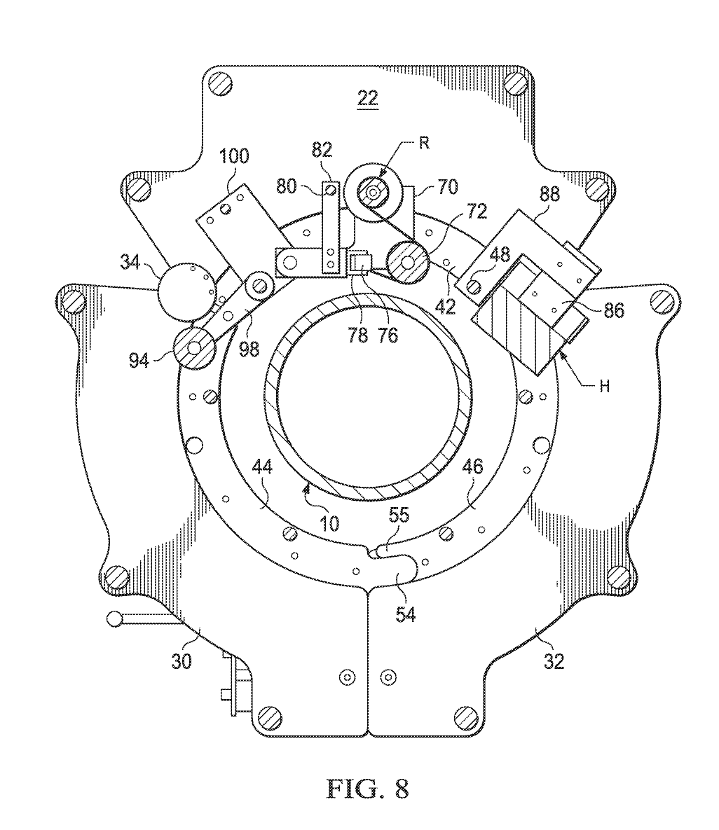

The mounting plates 70 are movable by forces from a piston or other force applying mechanism between an engaged position (FIG. 7) where the applicator roller 72 is urging the material of the sheet S into contact with the pipe joint 20, and a retracted position (FIG. 8) where the reel is accessible for loading, unloading or other purposes. A grip rod or bar 80 is mounted extending between support posts 82 which extend upwardly from connection with support arms 68. The grip rod 80 is adapted to be engaged and allow manual movement and adjustment of the relative position of the storage reel R with respect to the pipe joint 20.

The sheet S passes from the storage reel R and under the applicator roller 72 and is urged into initial engagement (FIG. 7) at a starting end portion to the pipe joint 20. After initial placement, the roller 72 moves slightly in reverse to roll down the leading edge of the material from the grip bar 76 into contact with the pipe joint, then roller 72 moves forward. The motor M continues to rotate the transport carriage T with respect to the frame F circumferentially about the pipeline. The sheet is subject to a tensile force because of the spacing of the applicator roller 72 and the storage reel R. The applicator roller 72 further exerts a compressive force on the material of the sheet S as it moves into engagement with the pipe joint. As movement of the transport carriage enters a second rotation about the pipeline 10, the synthetic resin of the sheet is urged into contact with the material applied during the previous rotation. The roller 72 is formed of a silicone rubber material which is hard enough to press the thermoplastic material of the sheet S to bond to the parent coating in the overlap area and to itself on each successive wrap. The silicone rubber material of roller 72 is also flexible enough to conform the material over the weld cap or weld seam where the two sections of pipe are joined together. The silicone rubber of roller 72 is also flexible enough to conform the thermoplastic material over the chamfer edges and overlap area at the pipe joint. The roller 72 is also to smooth expel air bubbles which form under the sheet material as it is applied. The silicone rubber of roller 72 is also non-adhesive and does not stick to the applied sheet material. The roller is also durable to last in field use. It is to be noted that with the present invention, the roller 72 does not need to be exposed to heat from a heater in order to function. A suitable material for the roller is Silicone with a Shore a hardness of approximately 10. The pipe machine P includes one or more infrared heaters H mounted on the transport carriage T spaced an arcuate distance on the transport carriage T in the direction of rotational travel of the transport carriage circumferentially about the pipe joint 20, in the embodiment shown clockwise in the views illustrated in FIGS. 7 and 8. The number of heaters on the machine P is based on the diameter of the pipeline, application time requirements and other pipeline installation considerations. The heater H is preferably an infrared panel heater, of suitable lateral dimensional width and output heat wattage depending on pipeline and joint size, available from Tempco Electric Heater Corporation.

With the present invention, infrared heat applied to the sheet material after it is wrapped provides significant advantages over other known heat sources. Infrared heat provides even and uniform application of heat across the full width of the joint and overlap area without hot or cold spots in the sheet material. With other known techniques, use of a hot air blower from a gas heat burner box provides unpredictable heating results and hot spots. An electric heater also provides uneven heating results in the sheet, and an open flame is both uneven and, as previously mentioned, can thermally age the material. The heater H applies heat to the parent coating in the overlap area ahead of the sheet application to allow the sheet to bond to the parent coating of the overlap. After the first wrap is completed, the heater heats the top layer of the sheet of synthetic resin material prior to each successive wrap, on the pipe joint. The amount of heat applied and the desired temperature to be obtained in the material is based on the particular material selected for use as the applied coating, the spacing of the heater from the applied material, and the rotational speed of the machine about the pipeline. Sufficient heat is applied to maintain the thermoplastic material between its softening point and its melt point while the machine P is mounted over the pipe joint.

Application of heat to the parent coating in an even manner across the wrap area and the adjoining chamfer and overlap area by infrared heat from the heater H avoids the need for special preheating or machining of the chamfer/overlap area. The chamfer/overlap area only needs to be buffed clean prior to coating. The onboard heater H is an onboard or integral component of the machine P. It is to be noted that with the present invention, the sheet material S is at ambient temperature when it is placed on the reel R. There is no need to preheat the thermoplastic material of the sheet S before it is loaded on the reel R. The heater H applies heat at a level to beat the sheet material S for wrapping and maintains the material between its softening point and its melt point when the machine P is operating.

The beater H receives electrical power over conductors from an electrical power supply. The conductors are wrapped on connector rods 48 and 52 as the transport carriage rotates about the pipe joint.

This eliminates the need to preheat the thermoplastic material elsewhere in a separate external oven before its application as a wrap. This is an operational advantage in a pipe laying operation. Stoppages, problems or delays in other steps in the pipe laying operation unrelated to pipe joint coating can interrupt or stop the timing of the field joint coating operation, or require starting of coating application with an inadequately heated sheet. Achieving the proper preheat time in the external oven, with no excess heating of the sheet material can be difficult in these conditions. Preheated thermoplastic is also hot to handle in moving form the oven to the pipe joint and requires careful handling. Carrying hot rolls of thermoplastic from the oven to the joint can be cumbersome particularly in the cramped conditions of the offshore environment. When preheated, thermoplastic material is in a state where contaminants can easily stick to it, thereby spoiling the material. Moving the heated material sheet from the oven to the pipe increased this possibility.

The heater H is mounted extending in the direction of the longitudinal axis of the pipeline and at each end on a mounting plate 86 of a heater mounting bracket 88. The heater mounting bracket 88 is mounted for pivotal movement on the support rod 48 extending between the central connector segments 42 of the support rings 40. The heater H is movable by forces from a piston or other force applying mechanism between a heat application position (FIG. 7) where the heater is facing the applied material of the sheet S which has been urged into contact with the pipe joint 20, and a retracted position (FIG. 8) where the heater is accessible for monitoring, inspection, service or other purposes.

The pipe coating machine P includes a smoothing roller 94 rotatably mounted at each end on support arms 98 which are each mounted to a tabs or plate 100 mounted with central connector segments 42 of the support rings 40. The smoothing roller 94 is formed of a like material to the applicator roller 72 for similar reasons. The support arms 98 are each mounted for pivotal movement with respect to the support plate 71 and central connector segment 42 of the support rings 40.

In this manner, the smoothing roller moves from a contact position (FIG. 8) to a retracted position (FIG. 7). The smoothing roller 94 is spaced an arcuate distance on the transport carriage T from the heater H in the direction of rotational travel of the transport carriage T circumferentially about the pipe joint 20. The applied synthetic resin material of the sheet S, and particularly its outer surface portions, are presented to the smoothing roller 94 is in a heated condition. The smoothing roller 94 is thus capable of removing possible irregularities, air bubbles or uneven portions, which might be present in the applied synthetic resin material before the applied layer of sheet material rotates back into position to the applicator roller 72 for receiving a further new layer of such material by cylindrical wrapping.

In the operation of the present invention, after the stub ends of pipe sections 12 and 14 are welded together as lengths of the pipeline 10, the resultant pipe joint 20 is then cleaned about its exterior surface. A suitable technique for this is that of U.S. Pat. No. 7,059,945 which is assigned to the assignee of the present application. After inspection, the cleaned pipe joint is then subjected to induction heating by a pipe induction heater of conventional type, available from a number of sources. Based on the material used in the sheet S, the fusion bonded epoxy coating components are applied to the heated pipe joint 20 and allowed to cure or harden.

The pipe coating machine P is then moved into position and the pipe joint 20 is coated. The sheet S of synthetic resin material is then affixed at a starting end portion or segment and the transport carriage T begins rotation in its circumferential path about the pipe joint 20. As the transport carriage moves, the synthetic resin sheet S is deployed from the reel R and urged into contact with the pipe joint 20 across the width of the bare metal of the pipe joint 20. Pressure is also applied to urge the sheet material into contact as it is being wrapped. The applied synthetic resin sheet is heated to a controlled temperature by the heater H after its application as it is being wrapped in successive layers over the joint. After heating, the wrapped portion of heated synthetic material move under the smoothing roller 94 for removal of any irregularities or uneven portions which might be present in the applied synthetic resin material. Wrapping continues during deployment of the sheet material from the reel, and the sheet is kept under tension as it is wrapped onto the pipe joint. The heated sheet material also fuses as it is being wrapped with the adjacent edges of the heated outer protective coating 16 and 18 and forms a seamless and fluid-impermeable barrier in the pipeline 10 in the area of the joint 20. The heated resin sheet S is cylindrically wound over the joint 20 in successive layers until the desired coating thickness is obtained. This may be a thin single wrap or multiple wraps for increased thickness, protection and thermal properties. The successive layers of sheet material S thus form an integral protective coating over the pipe joint 20 to form an integral protective synthetic resin coating over the pipe joint and the adjacent coated pipe sections.

It should be understood that while the drawings and description here show a single reel R and applicator roller 72 on the machine P, it is also possible to mount two or more reels and applicators to simultaneously apply two or more sheets at the same time with each wrapping turn around the pipe. This can be particularly advantageous for large pipe diameters or to reduce the application cycle time.

From the foregoing, it can be seen that the pipe joint coating machine according to the present invention provides numerous advantages over machines and practices presently available. The present invention does not use the open flame heat source used for Heat Shrink Sleeves and Flame Spray. As noted, use of open flame techniques is a safety risk, potentially provides uneven heat and application, and can thermally age the material, reducing installed service life. The present invention also helps insure repeatable quality for each pipe joint coated due to even application of heat roller design and automated process. In contrast, the Heat Shrink Sleeve and Flame Spray systems depend on operator skill and consistency to achieve a quality coating.

The present invention leaves one exposed longitudinal seam with two complete wraps of material below that seam instead of numerous spiral seams which are formed in the spiral tape wrap techniques. The present invention requires three revolutions to apply the sheet, or less, if multiple applicators are mounted, whereas the spiral tape wrap solution requires sixteen or more revolutions to coat the joint. With the heater mounted onboard the machine P as a component, there is no need for a separate external preheat oven. This is an operational advantage since pipe-laying operations may start, stop or move faster or slower and it is difficult coordinating the correct preheat oven time with this changing schedule. The present invention avoids handling hot, preheated sheet material, which is a cumbersome process and renders the heated material prone to contamination. Infrared heat provides even heat to ensure the thermoplastic material is bonded to the parent coating and itself. Infrared heat also avoids hot spots or cold spots in the sheet material that could degrade the material or result in disbondment problems. Additionally, as noted, the present invention can perform pipe joint coating with several different types of sheet material available from various manufacturers according to the particular ground or water conditions and coating requirements.

The invention has been sufficiently described so that a person with average knowledge in the matter may reproduce and obtain the results mentioned in the invention herein Nonetheless, any skilled person in the field of technique, subject of the invention herein, may carry out modifications not described in the request herein, to apply these modifications to a determined structure, or in the manufacturing process of the same, requires the claimed matter in the following claims; such structures shall be covered within the scope of the invention.

It should be noted and understood that there can be improvements and modifications made of the present invention described in detail above without departing from the spirit or scope of the invention as set forth in the accompanying claims.

What is claimed is:

1. A method of applying a protective coating to a pipe joint between welded end stubs of coated sections of pipe for a pipeline with an unheated sheet of synthetic resin from a storage reel on a transport carriage mounted on the pipeline, the method comprising the steps of:
unreeling the unheated sheet of synthetic resin from the storage reel;
applying the unheated sheet of synthetic resin to the pipe joint;
applying pressure to the unheated sheet of synthetic resin as it engages the pipe joint to press the synthetic resin on the pipe joint into a unitary coating;
heating the unheated sheet of synthetic resin after its application to the pipe joint from the storage reel; and
rotating the transport carriage about the pipe joint to cylindrically apply successive layers of the unheated sheet of synthetic resin to the pipe joint.

2. The method of claim 1, further comprising the step of:
applying tensile forces to the unheated sheet of synthetic resin as it is being applied to the pipe joint.

3. The method of claim 1, further comprising the step of:
smoothing the heated sheet of synthetic resin after it is applied to the pipe joint.

4. The method of claim 1, wherein the step of heating comprises applying infrared heat.
